(19) United States
(12) Patent Application Publication
(10) Pub. No.: US 2007/0296711 A1
(43) Pub. Date: Dec. 27, 2007

(54) Techniques for device display navigation

(75) Inventors: Dawson Yee, Bellevue, WA (US); Dan A. Knudson, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/451,734

(22) Filed: Jun. 13, 2006

(51) Int. Cl. G09G 5/00; G06F 3/048

(52) U.S. Cl. 345/184; 345/156; 715/860; 715/856; 715/857

(57) ABSTRACT

Techniques are provided for vertical navigation of displayed content. A physical wheel on a device is provided for navigating through content displayed on a display associated with the device. The physical wheel is moved in a direction and a distance about its rotational axis to indicate a scrolling direction and corresponding scrolling amount. The physical wheel is indexed in accordance with a display unit size associated with the content displayed.

### BACKGROUND

In connection with displaying content on a device, such as a user computer, a user may utilize a mouse or arrows on an attached keyboard. The scroll wheel of mouse and/or arrow keys may be used to indicate a scrolling movement in the horizontal and/or vertical direction. A user may navigate through content displayed on a computer display device using the mouse and/or arrow keys, for example, when navigating through content that is not able to be displayed at a single instance on the display device.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques are provided for vertical navigation of displayed content. A physical wheel on a device is provided for navigating through content displayed on a display associated with the device. The physical wheel is moved in a direction and a distance about its rotational axis to indicate a scrolling direction and corresponding scrolling amount. The physical wheel is indexed in accordance with a display unit size associated with the content displayed.

### DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment illustrating an environment that may be utilized in connection with the techniques described herein;

FIG. 2 is an example of components that may be included in an embodiment of a device for use in connection with performing the techniques described herein;

FIG. 3 is another illustrative example of components that may be included in an embodiment of a device for use in connection with performing the techniques described herein; and

FIG. 4 is an example representation of a side view of an embodiment of the scroll display wheel of FIG. 3;

FIGS. 5 and 6 are examples illustrating the display of content in connection with the techniques described herein; and

FIG. 7 is a flowchart of processing steps that may be performed in an embodiment in connection with the techniques described herein.

### DETAILED DESCRIPTION

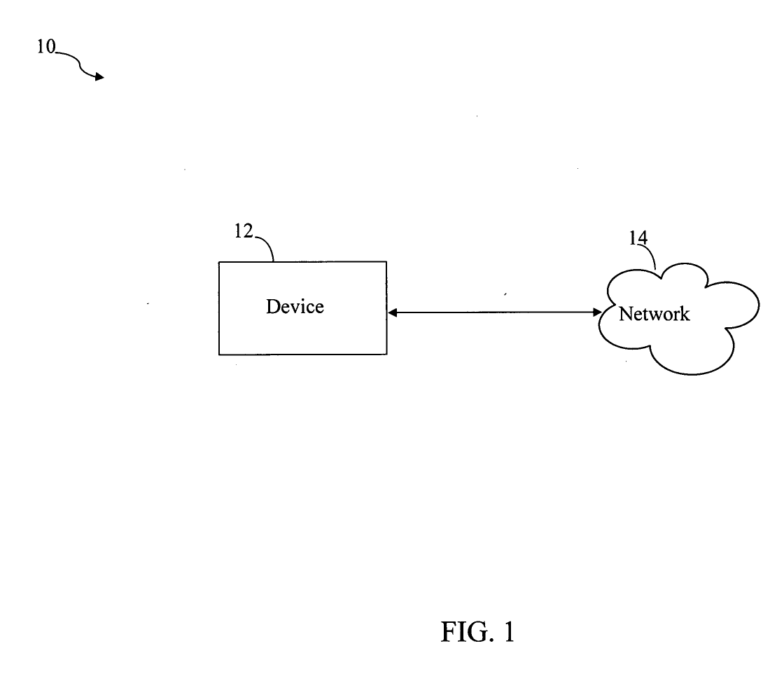

Referring now to FIG. 1, illustrated is an example of a suitable computing environment in which embodiments utilizing the techniques described herein may be implemented. The computing environment illustrated in FIG. 1 is only one example of a suitable computing environment and is not intended to suggest any limitation as to the scope of use or functionality of the techniques described herein in connection with device display navigation techniques. Those skilled in the art will appreciate that the techniques described herein may be suitable for use with other general purpose and specialized purpose computing environments and configurations. Examples of well known computing systems, environments, and/or configurations include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The techniques set forth herein may be described in the general context of computer-executable instructions, such as program modules, executed by one or more computers or other devices. Generally, program modules include routines, programs, objects, components, data structures, and the like, that perform particular tasks or implement particular abstract data types. Typically the functionality of the program modules may be combined or distributed as desired in various embodiments.

Included in FIG. 1 are a device 12, and a network 14. The device 12 that may be used in connection with the techniques described herein may be a any wired or wireless device having connectivity to the network. The device 12 may be, for example, a phone, a mobile communications device, or a user computer. The mobile communications device may be, for example, a wireless device such as a mobile phone or a PDA. The device 12 included in FIG. 1 and the particular devices that may be described herein are exemplary for purposes of illustrating the techniques described herein in connection with device display navigation. Any device that has connectivity to the network 14 and having the functionality described herein may be included in an embodiment. Additionally, although a single device is illustrated, an embodiment may include one or more devices. The device 12 may include a processor used to execute code included in one or more program modules. Described in more detail elsewhere herein are program modules that may be executed by the devices in connection with the techniques described herein. The device 12 may operate in a networked environment and communicate with other devices, such as a server computer, not shown in FIG. 1. For example, in one embodiment, the device 12 may be a communications device included in a network of an IP telephony system.

It will be appreciated by those skilled in the art that although the device 12 is shown in the example as communicating in a networked environment, the device 12 may communicate with other components utilizing different communication mediums. For example, the device 12 may communicate with one or more components utilizing a network connection, and/or other type of link known in the art including, but not limited to, the Internet, an intranet, or other wireless and/or hardwired connection(s).

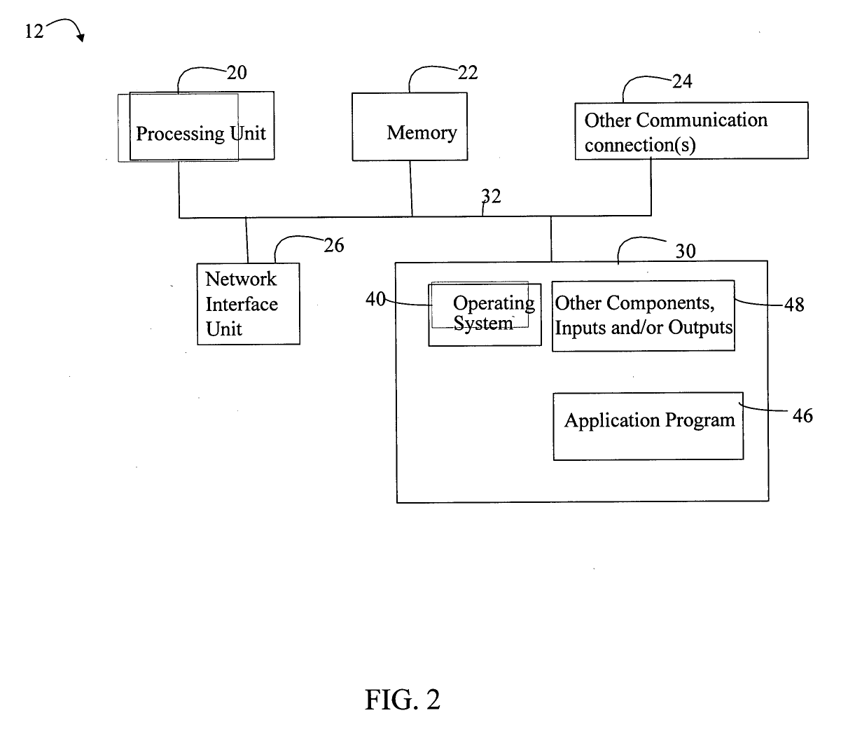

Referring now to FIG. 2, shown is an example of components that may be included in a device 12 as may be used in connection with performing the various embodiments of the techniques described herein. The device 12 may include one or more processing units 20, memory 22, a network interface unit 26, storage 30, one or more other communication connections 24, and a system bus 32 used to facilitate communications between the components of the device 12.

Depending on the configuration and type of device 12, memory 22 may be volatile (such as RAM), non-volatile (such as ROM, flash memory, etc.) or some combination of the two. Additionally, the device 12 may also have additional features/functionality. For example, the device 12 may also include additional storage (removable and/or non-removable) including, but not limited to, USB devices, magnetic or optical disks, or tape. Such additional storage is illustrated in FIG. 2 by storage 30. The storage 30 of FIG. 2 may include one or more removable and non-removable storage devices having associated computer-readable media that may be utilized by the device 12. The storage 30 in one embodiment may be a mass-storage device with associated computer-readable media providing non-volatile storage for the device 12. Although the description of computer-readable media as illustrated in this example may refer to a mass storage device, such as a hard disk or CD-ROM drive, it will be appreciated by those skilled in the art that the computer-readable media can be any available media that can be accessed by the device 12.

By way of example, and not limitation, computer readable media may comprise computer storage media and communication media. Memory 22, as well as storage 30, are examples of computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, (DVD) or other optical storage, magnetic cassettes, magnetic tape, magnetic disk storage or other magnetic storage devices, or any other medium which can be used to store the desired information and which can accessed by the device 12. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The device 12 may also contain communications connection(s) 24 that allow the user computer to communicate with other devices and components such as, by way of example, input devices and output devices. Input devices may include, for example, a keyboard, mouse, pen, voice input device, touch input device, etc. Output device(s) may include, for example, a display, speakers, printer, and the like. These and other devices are well known in the art and need not be discussed at length here. The one or more communications connection(s) 24 are an example of communication media.

In one embodiment, the device 12 may operate in a networked environment as illustrated in FIG. 1 using logical connections to remote computers through a network. The device 12 may connect to the network 14 of FIG. 1 through a network interface unit 26 connected to bus 32. The network interface unit 26 may also be utilized in connection with other types of networks and/or remote systems and components.

One or more program modules and/or data files may be included in storage 30. During operation of the device 12, one or more of these elements included in the storage 30 may also reside in a portion of memory 22, such as, for example, RAM for controlling the operation of the device 12. The example of FIG. 2 illustrates various components including an operating system 40, one or more application programs 46, and other components, inputs, and/or outputs 48.

The operating system 40 may be any one of a variety of commercially available or proprietary operating systems. The operating system 40, for example, may be loaded into memory in connection with controlling operation of the user computer. One or more application programs 46 may execute in the user computer 12 in connection with performing user tasks and operations.

The one or more application programs 46 may vary with the particular device. For example, in one embodiment in which the device 12 is a computer, the application may be code which monitors the activity on the computer 12 causing display of a screensaver when there is inactivity. In one embodiment, the device 12 may include an application program 46 that is a client-side calendar and scheduling program.

Described herein in following paragraphs are techniques that may be used in connection with navigating through content displayed on a display device. The techniques described herein may be used on a device in which there are no arrow keys of an attached keyboard or mouse device as may be used in connection with existing techniques to navigate through content such as may be displayed, for example, on a computer display device. The techniques described herein utilize a physical scroll display wheel or knob that may be included in a device. In an embodiment of a device in which one or more components may be included, the foregoing wheel may be included on a component used as a display device for content. The wheel may be used to navigate through displayed content.

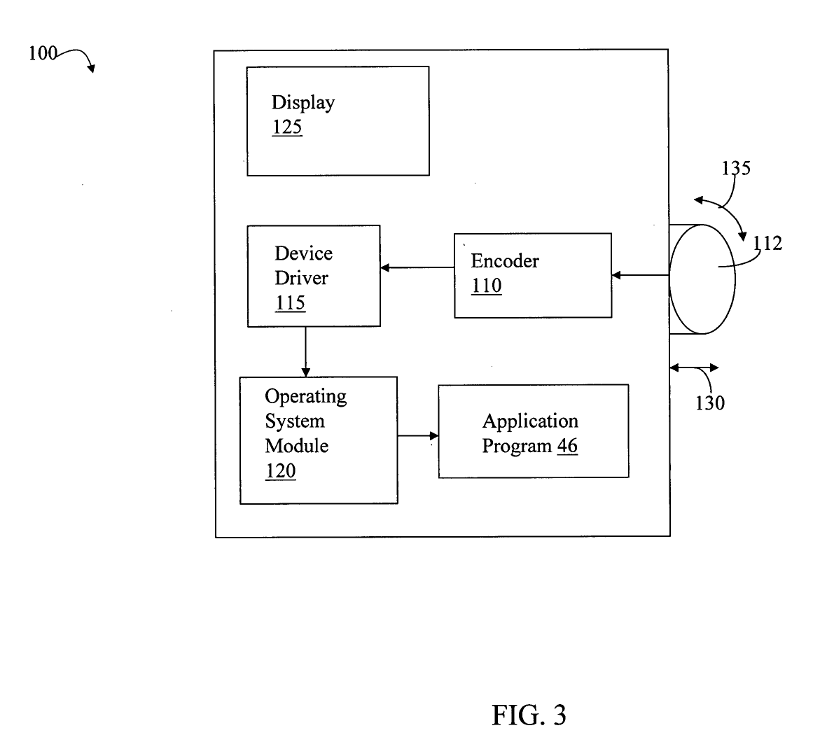

Referring now to FIG. 3, shown is another example illustrating components that may be included in an embodiment of a device for use in connection with the techniques described herein. The example 100 includes a physical scroll display wheel 112, an encoder 110, a device driver 115, an operating system module, and a display area 125. In one embodiment as illustrated in 100, the wheel 112 may be mounted on a side of a device including a display 125 used to display content. In operation, the wheel 112 may be rotated in both a clockwise and counterclockwise rotational direction as indicated by 135. An embodiment may also provide for the wheel which can be depressed such that, in operation, the wheel 112 may be capable of movement along a linear axis as indicated by 130 when the wheel is depressed and then subsequently released.

The wheel 112 may be a mechanical wheel made of any one or more materials known in the art such as a plastic. The encoder 110 may interface and communicate with the wheel 112. The encoder 110 may detect and record any movement of the wheel 112 and report such information to a device driver 115. In turn, the device driver 115 may report such information as well as the occurrence of the event, the wheel movement, to an operating system module 120. The module 120 may communicate with an application program 46, for example, a word processing application, which may be displaying the content in display area 125 to accordingly perform any content update to the display area 125 in response to the movement of wheel 112. In operation, when the wheel moves in a rotational direction as indicated by 135, a user may be scrolling through content being displayed such as when the content cannot be displayed at a single instance in the display area 125. When the wheel moves in a linear direction as a result of depressing and releasing the wheel as indicated by 130, a user may be selecting a currently viewed item.

In one embodiment described herein, rotational movements of the wheel may accordingly correspond to movements in displayed content in a vertical direction. For example, movement of the wheel in a clockwise direction may result in a first or forward scrolling direction through content being viewed in the display area 125. Movement of the wheel in a counterclockwise direction may result in scrolling through content in a vertical direction opposite to that associated with the clockwise direction.

In one embodiment, the movement of the wheel may be characterized as the occurrence of an asynchronous event and may be processed as such. For example, an embodiment may process an event corresponding to a movement of the wheel 112 in a manner similar to processing of mouse scroll wheel events.

It should be noted that an embodiment may include any one or more of the features of the wheel 112 as described herein. For example, an embodiment may include a wheel 112 which may be moved in a rotational direction as indicated by element 135 but without having the wheel capable of movement along a linear axis as indicated by 130. Accordingly, such an embodiment may omit the features described herein associated with the depression of the wheel 112. An embodiment may also include one or more of the features described herein in combination with other features as known to those skilled in the art.

It should be noted that although the wheel 112 is illustrated as mounted in a particular position on the side of the device, the wheel 112 may be mounted in any one of a variety of different positions on a side or other surface of the device, or component of the device such as a component including a display area. Such a position may be within proximity to the display area for use in connection therewith. The wheel 112 may also be mounted, or otherwise mountable, on the left and/or right hand side in accordance with the left-handedness or right-handedness of a user. The wheel 112 may also be mounted in a side position of a component of a device in which the component does not include the display area. For example, if the device is a computer, the computer may include a first component that includes the processor, a second display component such as a monitor, and one or more other components such as a keyboard, mouse, and the like. The wheel 112 may be mounted, for example, on a side surface of a keyboard while the content is displayed on the monitor, or a side surface of a display component such as the monitor upon which the content is also displayed. If the device is a phone including a handset and base, the wheel may be mounted on base component also including the display.

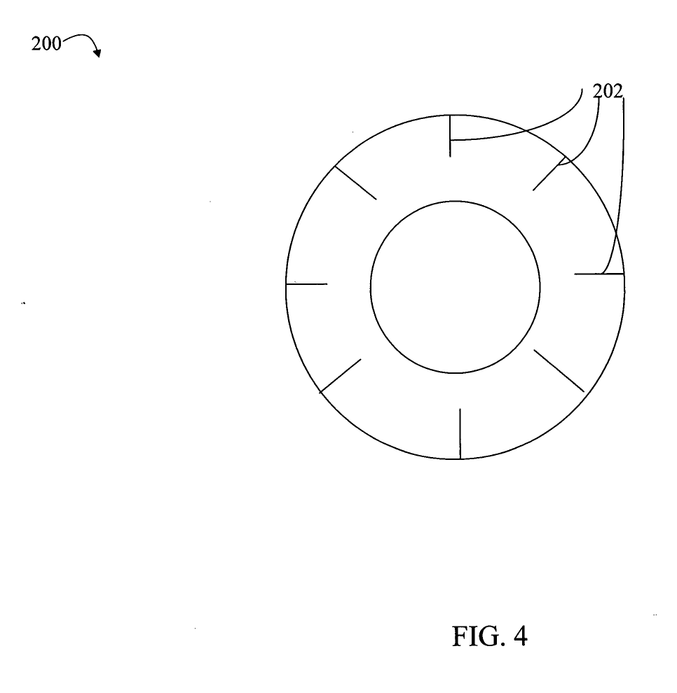

Referring now to FIG. 4, shown is an example of a side view of one embodiment of the wheel 112 from FIG. 3. The example 200 illustrates a wheel include multiple notches or index points 202. As the wheel moves in a rotational direction at one of the index points, a clicking or other physical or sound effect may result to signify to the user the movement of the wheel to such a point. For example, if two such effects occur, the user receives feedback that he/she has rotated the wheel an amount corresponding to two such index points.

In one embodiment, the amount of content which is scrolled through as a result of moving the wheel from one index point to another in a rotational direction may be in accordance with an amount of an index point increment. In one embodiment, the wheel may be indexed in accordance with the character font size of the content being displayed. As such, movement of the wheel in a rotational direction results in a movement or scrolling through content in accordance with the font size of the content displayed. For example, each time the wheel is moved a rotational distance of one index point, the displayed content may be scrolled through by a single line of displayed text. If the text being displayed is a 10 point font, then movement one index point in a rotational direction causes the currently displayed content to advance in a direction corresponding to the wheel movement an amount in accordance with the 10 point displayed font. If text being displayed is a 24 point font, then movement of the wheel by one index point may cause the display to be updated in accordance with the 24 point font. In one embodiment, the index amount may adjust automatically in accordance with the font size of the currently displayed content.

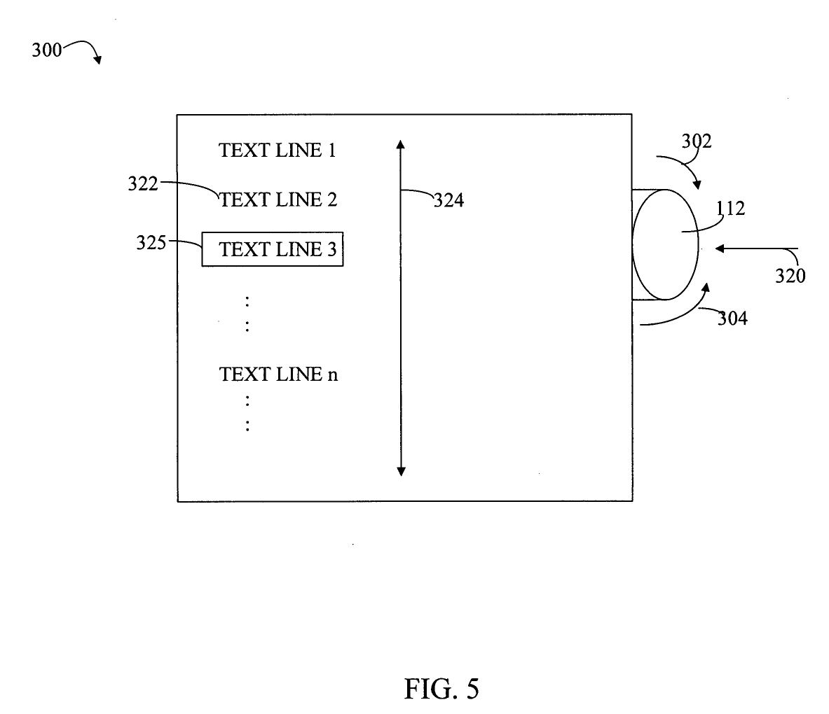

Referring now to FIG. 5, shown is an example illustrating scrolling of displayed content in accordance with movements of the wheel. The example 300 illustrates content as may be displayed on a display device having wheel 112. A currently highlighted line of the displayed content may be indicated by 325. Movement of the wheel 112 may accordingly cause the display to be updated by displaying text corresponding to scrolling in an upward or downward vertical direction as indicated by 324. As a user may move the wheel 112, for example, in a clockwise direction 302 corresponding to a user scrolling through displayed content in a forward manner. In response to movement of the wheel 112 in a clockwise direction by one index point, the total content displayed may be shifted or advanced one line. Additionally, the currently highlighted line indicating the current line may also be accordingly advanced one line. For example, if line 322 is the current line, as indicated by highlighting at a first point in time. The user scrolls in direction 302 and the current line may become 325 and may be accordingly highlighted. Additionally the particular content displayed will also advance by one line in accordance with the single index point by which the user rotationally moved the wheel 112 in direction 302. A movement of the wheel 112 as illustrated by 304 may cause the display of text to be adjusted in an opposite manner from that just described with respect to a movement in the rotational direction indicated by 302. For example, if movement of the wheel in the direction 302 corresponds to forward scrolling through content, movement of the wheel in the direction 304 corresponds to backward scrolling through content. The displayed content and the current line as may be indicated through highlighted or another visual indicator may also be updated in accordance with the rotational direction and amount by which the wheel 112 is moved.

It should be noted that an embodiment may also include a wheel with an acceleration mode or rate to provide for an accelerated rate of scrolling through content. In one embodiment, if a user moves the wheel from index point to index point at a slow rate, then advancement or scrolling of the displayed content may occur at a non-accelerated rate. If the user advances the wheel from index point to index point at a faster rate so that, for example, the amount of time detected between two consecutive index points is less that a predetermined threshold, it is determined that the user wishes to view content at a faster or accelerated rate. As such, the rate at which the content in the display may be updated is in accordance with an accelerated rate. The acceleration may be triggered when the rate at which the user moves the wheel (e.g., as may be determined by measuring the time associated with each of two consecutive index points) is at a predetermined threshold. When this threshold is reached, the content may be displayed at an accelerated rate. The threshold may be set by a user/user configurable as an option. When in the acceleration mode, the display movement may occur at an accelerated rate greater than when displaying content in response to movement of the wheel one index point at a time.

If the user depresses the wheel 112 as indicated by 320, the current line of displayed content may be selected. As described herein in one embodiment, a current line of displayed content may be indicated by highlighting, bolding, coloring, or otherwise visually differentiating the current line from the other displayed content. Depression of the wheel may be used to indicate a selection of the current line or other currently indicated content by the user. For example, a current position of displayed content may be highlighted. Pushing or depressing the wheel indicates user selection of the item at the currently highlighted position. If the device is a phone with a display area, the user may be viewing a log of missed calls, an electronic address book with contact information, and the like. If the list corresponds to entries of an electronic address book with contact information, a list of the names of individuals in the book may be displayed. The user may scroll through the list by turning the wheel in a circular movement one notch at a time or at an accelerated rate by accelerating the rate at which the wheel is turned in a rotational direction. With movement of the wheel for each index point, the display may be accordingly updated to display contents of the list in accordance with the rate, amount and direction in which the wheel is moved, and a display unit size in accordance with the size of the currently displayed content. A different entry of the list may be highlighted with each click of the wheel as the user indexes through the list. If the list is long and the user is looking for a particular entry at the end of the list, the user may scroll at an accelerated rate until a particular point. When the user is viewing an entry of the address book that the user wishes to select, the user may depress the wheel. In response to depressing the wheel indicating selection of a currently highlighted and displayed individual in the list, additional information, such as the address book entry of the selected individual entry, may be subsequently displayed.

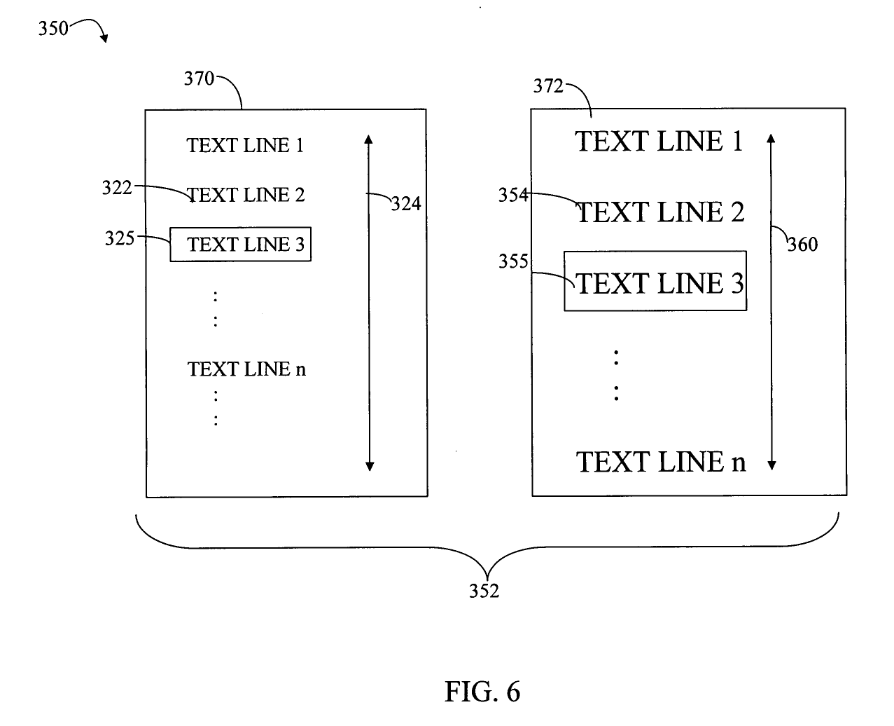

Referring now to FIG. 6, shown is another example illustrating the techniques described herein for navigating through displayed content. In the example 350, the element 352 includes content as may be displayed on two different devices. For a first device, content is displayed as represented by 370. For a second device, content is displayed as represented by 372. It should be noted that for purposes of simplicity of illustration, the wheel of each device has been omitted from the example 350 but is included on the foregoing first and second devices as described herein. Movement of the wheel on the first device in a rotational direction causes movement or scrolling through displayed content in a vertical direction as indicated by 324. Similarly, movement of the wheel on the second device in a rotational direction causes movement or scrolling through displayed content in a vertical direction as indicated by 360.

In a non-accelerated mode, movement of the wheel of the first device one index point may cause the current line as indicated by highlighting, bolding, and the like, to advance from line 322 to line 325. Additionally, the content viewed may be advanced by a single line as well, for example, so that TEXT LINE 1 is not displayed and one additional new line of content is included in the displayed content in accordance with the advancement of scrolling through the content through movement of the wheel one index point in a counterclockwise direction. Content for the first device may be displayed in a 14 point font and one index point in this example may correspond to the font size of a single line which is 14 points for the first device.

In a non-accelerated mode, movement of the wheel of the second device one index point may cause the current line as indicated by highlighting, bolding, and the like, to advance from line 354 to line 355. Additionally, the content viewed may be advanced by a single line as well, for example, so that TEXT LINE 1 is not displayed and one additional new line of content is included in the displayed content in accordance with the advancement of scrolling through the content through movement of the wheel one index point in a counterclockwise direction. Content for the second device may be displayed in a 20 point font and one index point in this example may correspond to the font size of a single line which is 20 points for the second device.

In accordance with the techniques described herein, the scroll wheel may be indexed in accordance with the character font size of the displayed content so that the physical amount of rotational wheel scroll corresponding to movement from one index point to a next index point corresponds to movement of the displayed content in accordance with the index point increment. In this example, the index point increment may correspond to the font size of a single line of displayed content although the amount associated with the index point increment may vary with the content displayed.

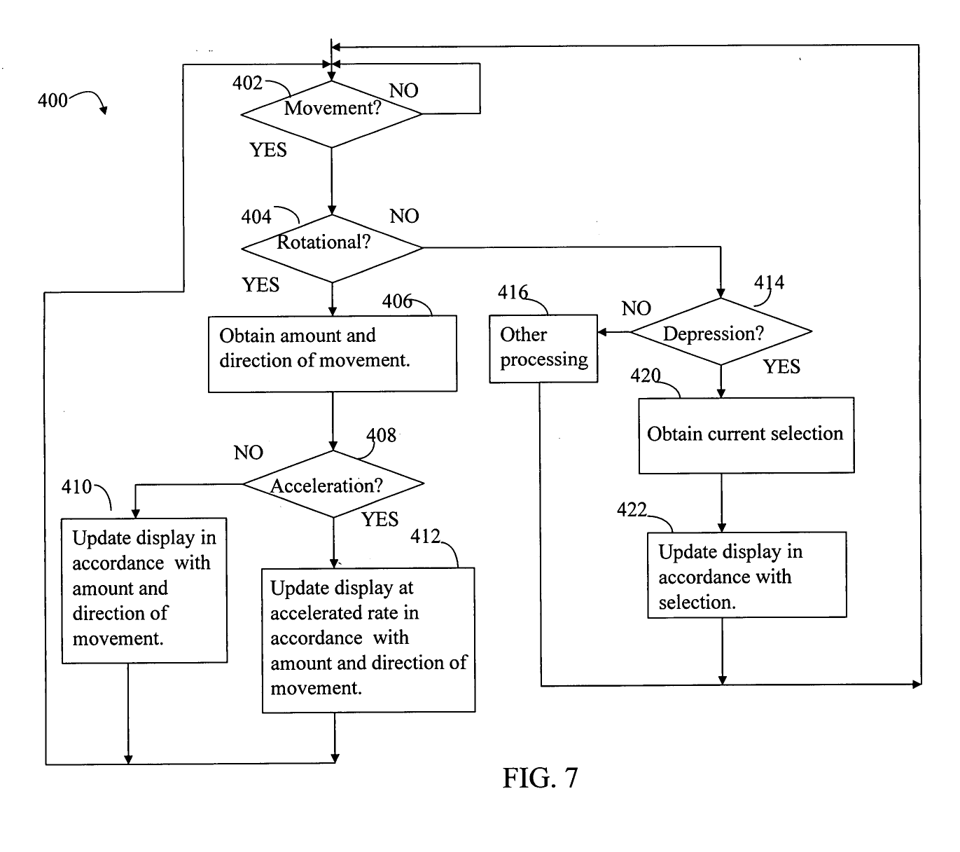

Referring now to FIG. 7, shown is a flowchart 4300 summarizing the processing steps just described in connection with the techniques described herein. At step 402, a determination is made as to whether movement of the scroll display wheel has been detected. If not, control returns to step 402 until step 402 evaluates to yes. If step 402 evaluates to yes, control proceeds to step 404 where a determination is made as to whether the movement of the wheel detected is rotational. If not, control proceeds to step 414 where a determination is made as to whether the movement is a depression of the wheel. If step 414 evaluates to no, control proceeds to step 416 where other processing is performed in accordance with the particular movement of the wheel. From step 416, control proceeds to step 402.

If step 414 evaluates to yes, control proceeds to step 420 to obtain the current selection as indicated by the depression of the wheel. At step 422, the display is updated in accordance with the current selection. As described elsewhere herein, for example, a user may be scrolling through a list of names included in an electronic contact list or address book. The currently selected list entry may be highlighted and the user may advance through the list by rotating the wheel. Rotation of the wheel may cause the currently selected entry, such as may be indicated by highlighting, to change. Depression of the wheel by the user indicates selection of the currently highlighted entry. In response to depression of the wheel for a currently selected entry, the display may be updated accordingly with information. For example, if the entry corresponds to an entry in an address book or contact list, the display may be updated to include the more detailed information regarding the selected entry. The particular action taken in response to a selection as indicated by depression of the wheel may vary with the display, content, and embodiment. For example, in one embodiment, depression of the wheel may be used in connection with selection of content. Selection of content may be performed, for example, as part of drilling down into a layer of content represented in accordance with a hierarchical structure. In another example, when viewing file content such as at a computer display, selection of a particular line of text in a file may result in a particular operation being performed with respect to the line of text, may result in display of one or more valid operations that may be performed with respect to the currently selected line, and the like. It should be noted that an embodiment may also enable/disable the selection option as indicated by depressing the wheel in accordance with the type of content. From step 422, control proceeds to step 402.

If step 404 evaluates to yes indicating that the movement of the wheel is rotational, control proceeds to step 406 where the amount and direction of rotational or angular wheel movement are obtained. At step 408, a determination is made as to whether acceleration through the content has been indicated. As described elsewhere herein, one embodiment may determine whether a user is scrolling through content at an accelerated rate in accordance with the time between successive rotational increments of the wheel If the amount of time between rotational increments is at or below a specified threshold, it may be determined that the user is scrolling through content at an accelerated rate. If step 408 evaluates to yes, control proceeds to step 412 to update the display at the accelerated rate in accordance with the amount and direction of movement and the display unit size of the displayed content. In one embodiment, when scrolling at an accelerated rate may result in a larger amount of content being scrolled through with each increment in comparison to a non-accelerated mode. From step 412, control proceeds to step 402.

If step 408 evaluates to no, control proceeds to step 410 to continue processing in a non-accelerated mode. At step 410, the display is updated in accordance with the amount and direction of movement for the non-accelerated mode as well as the display unit size of the displayed content. From step 410, control proceeds to step 402.

The techniques described herein may be used in connection with a variety of different devices and applications. For example, the techniques described herein may be used in connection with a display device of a computer when the user is viewing and scrolling through content. As another example, the techniques described herein may be used in connection with a phone device in which a component of the phone device includes a display area. A user may scroll through content, such as information regarding received phone calls, a contact list, and the like. The techniques described herein may be used in connection with any one or more devices which may or may not have a keyboard and/or mouse. As such, scrolling through displayed content may be performed using a physical scrolling wheel rather than the keyboard or mouse. The wheel may be indexed in accordance with a display unit size of the currently displayed content. The display unit size may automatically adapt to the size of the displayed content. An embodiment may also include an acceleration mode for use in connection with displaying content. An embodiment may also include a wheel which can be moved in a clockwise and counterclockwise rotational direction. The wheel may also move in a linear direction in connection with depressing the wheel to make a selection of currently displayed content. It should be noted that an embodiment may include one or more defined rates of acceleration for use in connection with the techniques described herein for content display.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for vertical navigation of displayed content comprising:
providing a physical wheel for navigating through content displayed on a display associated with said device, said physical wheel being mounted on a surface of a component of said device; and
moving the physical wheel in a direction and a distance about its rotational axis to indicate a scrolling direction and corresponding scrolling amount, wherein said physical wheel is indexed in accordance with a display unit size associated with the content displayed.

2. The method of claim 1, wherein said display unit size is in accordance with a font size of the content displayed.

3. The method of claim 1, wherein said device is a phone.

4. The method of claim 1, wherein said device is a computer.

5. The method of claim 1, wherein said device is a mobile communications device.

6. The method of claim 1, wherein said physical wheel is located on a side of said device.

7. The method of claim 1, further comprising:
updating a display area on which said content is displayed in accordance with said display unit size, said scrolling direction and said corresponding scrolling amount.

8. The method of claim 1, further comprising:
providing a visual indicator of a current portion of said content.

9. The method of claim 8, further comprising:
updating said visual indicator of a display area of said content to indicate a new current portion of said content in accordance with said display unit size, said scrolling direction and said corresponding scrolling amount.

10. The method of claim 8, wherein said current portion is indicated by highlighting said current portion.

11. The method of claim 8, wherein said current portion is indicated by bolding said current portion.

12. The method of claim 8, further comprising:
selecting said current portion by depressing and releasing said physical wheel causing said physical wheel to move along a linear axis in a first direction toward the device when depressed and an opposite direction when released.

13. The method of claim 1, wherein said physical wheel is moved at an accelerated rate in accordance with a threshold and said content displayed is accordingly updated at said accelerated rate, and wherein said content is otherwise displayed in accordance with a non-accelerated rate when said physical wheel is not moved at said accelerated rate.

14. A device comprising:
a display area for displaying content; and
a physical wheel placed in proximity to said display area for navigating through content displayed at said display area, wherein movement of the physical wheel in a direction and a distance about its rotational axis indicates a scrolling direction and corresponding scrolling amount, wherein said physical wheel is indexed in accordance with a display unit size associated with the content displayed in said display area, said physical wheel being mounted in proximity to said display area on a component of said device.

15. The device of claim 14, wherein said device is a phone and said display area is on a first component of said phone including said display area.

16. The device of claim 14, wherein a visual indicator is provided in said display area to indicate a current portion of said content.

17. The device of claim 14, wherein said display area on which said content is displayed is updated in accordance with said display unit size, said scrolling direction and said corresponding scrolling amount in response to a movement of said physical wheel.

18. The device of claim 16, wherein said physical wheel is capable of movement along a linear axis so that selecting said current portion is made by depressing and releasing said physical wheel causing said physical wheel to move along said linear axis in a first direction toward the device when depressed and an opposite direction when released.

19. A method for vertical navigation of displayed content comprising:
providing a physical wheel on a device for navigating through content displayed on a display associated with said device, said physical wheel being mounted in proximity to said display on a component of said device wherein said component includes said display; and
moving the physical wheel in a direction and a distance about its rotational axis to indicate a scrolling direction and corresponding scrolling amount, wherein said physical wheel is indexed in accordance with a display unit size associated with the content displayed, and wherein said physical wheel is moved along a linear axis in connection with selecting a portion of content displayed.

20. The method of claim 19, wherein said portion is selected by depressing and releasing said physical wheel causing said physical wheel to move along said linear axis in a first direction toward the device when depressed and an opposite direction when released.
